(19) United States
(12) Patent Application Publication
(10) Pub. No.: US 2009/0087773 A1
(43) Pub. Date: Apr. 2, 2009

(54) LIQUID DEVELOPING AGENT AND PROCESS FOR PRODUCING THE SAME

(76) Inventors: Yasushi Shinjiyo, Kawasaki-shi (JP); Masahiro Hosoya, Okegawa-shi (JP); Koichi Ishii, Kawasaki-shi (JP); Mitsunaga Saito, Inzai-shi (JP); Yoshihiro Tajima, Tano-gun (JP); Ken Takahashi, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/236,813

(22) Filed: Sep. 24, 2008

Related U.S. Application Data
(63) Continuation of application No. PCT/JP07/54241, filed on Mar. 6, 2007.

(30) Foreign Application Priority Data
Mar. 28, 2006 (JP) 2006-087749

(51) Int. Cl. G03G 9/125; G03G 5/00

(52) U.S. Cl. 430/114; 430/137.22

(57) ABSTRACT

A liquid developing agent includes a toner particle having a nuclear particle and a covering layer containing a wax, provided on the surface of the nuclear particle in which the wax has at least one of polar groups and aromatic substituent groups, is substantially insoluble in an electric insulation solvent at room temperature, has a melting point below a boiling point of the electric insulation solvent, and is dissolved in the insulation solvent at a temperature higher than the melting point.

### CROSS REFERENCE TO RELATED APPLICATIONS

This is a Continuation Application of PCT Application No. PCT/JP2007/054241, filed Mar. 6, 2007, which was published under PCT Article 21(2) in Japanese.

This application is based upon and claims the benefit of priority from prior Japanese Patent Application No. 2006-087749, filed Mar. 28, 2006, the entire contents of which are incorporated herein by reference.

### BACKGROUND OF THE INVENTION

1. Field of the Invention

The present invention relates to a liquid developing agent which can be developed using electrophoresis techniques.

2. Description of the Related Art

Conventionally, a photolithographic technique has played a central role as a technique for forming a fine pattern on the surface of a base material. However, although the resolution and performance have been increasingly improved in the photolithographic technique, huge and expensive manufacturing facilities are required and the production costs are also high depending on the resolution.

On the other hand, there is an increasing need of improvement in performance and price-reduction in the manufacturing fields of image display apparatuses as well as semiconductor devices. However, the above-described photolithographic technique can no longer satisfy such requirements.

Under such circumstances, a pattern forming technique using a digital printing technique is attracting attention. For example, an ink jet technique is beginning to be put into practical use as a patterning technique taking advantage of characteristics of the simplicity of the apparatus and the non-contact patterning process. However, resolution and productivity are still limited.

On the other hand, electrophoresis techniques including electrophotographic technologies using a liquid toner have an excellent possibility of price-reduction, high resolution, and high productivity. For example, the technique for forming a phosphor layer of a front substrate for flat-panel displays using such electrophoresis techniques is proposed in Jpn. Pat. Appln. KOKAI Publication No. 9-202995. In the method, a resin consisting of a nucleus portion which is insoluble or swells in an insulation solvent and an outer edge portion which swells or is dissolved in the insulation solvent is used as a resin component for the phosphor toner.

However, it is necessary to use a good solvent which can dissolve the resin completely and sufficiently at the time of toner particle production. Therefore, volatile organic solvents other than the insulation solvent must be used and further a resin whose SP value is controlled must be designed. It is difficult to control the original characteristics of a toner, such as electrostatic properties, adhesive properties, and cohesive properties and thus the range of selection of materials is limited.

### BRIEF SUMMARY OF THE INVENTION

The present invention has been made in order to solve such problems.

An object of the present invention is to provide a liquid developing agent capable of forming a toner layer which is excellent in electrostatic properties, adhesive properties, and redispersibility and is a thick film with a high resolution, high precision, and low cost.

A liquid developing agent according to the present invention comprises:

an electric insulation solvent;

a nuclear particle which is dispersed in the electric insulation solvent and has an average particle diameter of 1 to 30 mm;

a covering layer which is provided on the surface of the nuclear particle and contains a wax which has at least one of polar groups and aromatic substituent groups, is substantially insoluble in the electric insulation solvent at room temperature, has a melting point below a boiling point of the electric insulation solvent, and is dissolved in the insulation solvent at a temperature higher than the melting point; and

a toner particle containing a metallic soap added onto the covering layer.

A process for producing a liquid developing agent according to the present invention, comprises:

melting a wax which is substantially insoluble in the electric insulation solvent at room temperature, has a melting point below a boiling point of the electric insulation solvent, and is dissolved in the insulation solvent at a temperature higher than the melting point, while the wax is heated and stirred with the nuclear particle at a temperature below the boiling point of the electric insulation solvent;

then allowing the wax to be precipitated on the surface of the nuclear particle by cooling the wax to a degree below the melting point of the wax; and subsequently adding a metallic soap.

### BRIEF DESCRIPTION OF THE SEVERAL VIEWS OF THE DRAWING

FIG. 1 is a model view for explaining an example of the structure of toner particle contained in the liquid developing agent of the present invention.

FIG. 2 is a model view for explaining another example of the structure of toner particle contained in the liquid developing agent of the present invention.

FIG. 3 is a schematic diagram illustrating an apparatus to be used in the manufacture of the liquid developing agent of the present invention.

FIG. 4 is a schematic diagram of a sandwich cell for electrodeposition to which the liquid developing agent of the present invention can be applied.

### DETAILED DESCRIPTION OF THE INVENTION

The liquid developing agent of the present invention contains an electric insulation solvent and toner particles.

The toner particle has a nuclear particle, a covering layer containing a wax provided on the nuclear particle, and a metallic soap added on the covering layer. The particle diameter of the toner particle is 1 to 30 μm.

The wax to be used has at least one of polar groups and aromatic substituent groups, is substantially insoluble in the electric insulation solvent at room temperature, has a melting point below the boiling point of the electric insulation solvent, and is dissolved in the electric insulation solvent at a temperature higher than the melting point.

Here, it is noted that the covering layer covers at least a part of the surface of the toner particle.

In the liquid developing agent of the present invention, the adhesive properties of the toner particle are properly inhibited by allowing a covering layer to contain wax and thus the redispersibility of the toner particle is improved. Since the added metallic soap is sufficiently adhered, the electrostatic properties are improved. Thus, a toner layer of a thick film with high resolution and high fineness can be electrodeposited. When the toner layer that is once electrodeposited to an adherend is transferred to another adherend, the mold-release characteristics are improved.

Further, in the process for producing the liquid developing agent of the present invention, the wax which is substantially insoluble in the electric insulation solvent at room temperature, has a melting point below the boiling point of the electric insulation solvent, and is dissolved in the insulation solvent at a temperature higher than the melting point is first prepared. The wax is melted while being heated and stirred with the nuclear particle at a temperature below the boiling point of the electric insulation solvent. Thereafter, the wax is precipitated on the surface of the nuclear particle by cooling it to a degree below the melting point of the wax. Then, the metallic soap is added thereto.

When the process of the present invention is used, the above-described liquid developing agent can be produced.

According to the method of the present invention, the liquid developing agent can be produced by charging a solvent into a container, and just performing the temperature operation and stirring operation basically without performing complicated operations. Further, a large-scale and complicated apparatus is not necessary in the method of the present invention and the method is low in cost and simple.

According to another aspect of the liquid developing agent of the present invention, the covering layer containing a wax provided on a nuclear particle may further contain thermoplastic resin fine particles having an average particle diameter smaller than the nuclear particle. That is, the liquid developing agent according to another aspect of the present invention contains the electric insulation solvent and the toner particle. The toner particle has the nuclear particle, the covering layer containing the wax and thermoplastic resin fine particles having an average particle diameter smaller than the nuclear particle which is provided on the nuclear particle, and the metallic soap added on the covering layer. The particle diameter of the toner particle is 1 to 30 mm. Further, the wax to be used has at least one of polar groups and aromatic substituent groups, is substantially insoluble in the electric insulation solvent at room temperature, has a melting point below the boiling point of the electric insulation solvent, and is dissolved in the electric insulation solvent at a temperature higher than the melting point.

Adsorptive properties of the metallic soap to the toner particle are controlled by allowing thermoplastic resin fine particles to be adhered to or covered on the surface of the nuclear particle in combination with waxes. Thus, electrostatic properties can be adjusted. Further, the adhesive properties and cohesive properties of the toner particle can be controlled by using thermoplastic resin fine particles in combination with waxes. For example, when the toner layer that is once electrodeposited to an adherend is transferred to another adherend, the adhesive properties are controlled by forming a covering layer which substantially contains the wax as a main component without using thermoplastic resin fine particles. Thus, the mold-release characteristics can be enhanced and transcription characteristics can be improved.

On the other hand, when the toner layer electrodeposited is well fixed to an adherend, the adhesive properties are properly increased by using thermoplastic resin fine particles in combination with waxes, thereby reducing the mold-release characteristics.

Further, when the thermoplastic resin is adhered to the nuclear particle without using waxes, the resin materials must be selected taking into consideration the affinity for the insulation solvent, such as a solubility parameter (SP) value of the resin to be used. Uniform toner particles can be obtained using various thermoplastic resins without being restricted by the SP value by allowing fine particle-like thermoplastic resin to be adhered to or covered on the nuclear particle in combination with waxes.

The liquid developing agent further containing thermoplastic resin fine particles can be obtained by using another aspect of the process for producing the liquid developing agent of the present invention.

In the process for producing the liquid developing agent of the present invention, the wax which is substantially insoluble in the electric insulation solvent at room temperature, has a melting point below the boiling point of the electric insulation solvent, and is dissolved in the electric insulation solvent at a temperature higher than the melting point is first prepared. The wax is melted while a solution containing the wax, nuclear particle, and thermoplastic resin fine particles which have an average particle diameter smaller than the nuclear particle and are substantially insoluble in the electric insulation solvent is heated and stirred at a temperature below the boiling point of the electric insulation solvent. While allowing thermoplastic resin fine particles to adhere to the surface of the nuclear particle, the wax is precipitated on the surface of the nuclear particle by cooling it to a degree below the melting point of the wax. Then, the liquid developing agent can be obtained by adding the metallic soap to the solution and adhering the soap to the surface of the nuclear particle.

When the above method is used, the wax disperses and agitates the resin particles in a solution which is dissolved in the insulation solvent at a temperature higher than the melting point of the wax. Therefore, the melted wax plays a role of a dispersing agent of thermoplastic resin particles. Further, while precipitating the wax component on the surface of the nuclear particle, thermoplastic resin particles can be uniformly adhered by cooling the whole solution to below the melting point of the wax.

Thermoplastic resin fine particles may have an average particle diameter of 0.1 to 5 mm.

FIG. 1 shows the model view for explaining an example of the structure of toner particle contained in the liquid developing agent of the present invention.

As illustrated therein, a toner particle 10 contains a nuclear particle 1, a wax containing layer 2 which is covered on the surface of the nuclear particle 1, and a covering layer which is adhered to the surface of the wax containing layer 2 and contains a metallic soap (not shown).

The average particle diameter of the nuclear particle can be 1 to 30 mm. The average particle diameter is more preferably 1 to 10 mm, further it can be 2 to 8 mm. When the average particle diameter is less than 1 mm, it is difficult to allow the wax to be precipitated on one nuclear particle, and the nuclear particle tends to be a secondary particle in which the nuclear particle is aggregated. When the average particle diameter exceeds 30 mm, it is difficult to uniformly stir the nuclear particle. As a result, it tends to be difficult to allow the wax to uniformly precipitate.

The weight ratio of the toner particle to the insulation solvent can be 2:98 to 50:50 based on 100 parts by weight of the liquid developing agent.

When the weight ratio is outside of the above-described range, a large amount of solvent is required to obtain a predetermined thickness. Further, the toner particle is adhered to the portion other than the portion where a film is to be formed, which tends to cause contamination.

Further, The amount of the wax can be in the range of 5 to 200% by volume based on the nuclear particle, and the amount of the metallic soap can be in the range of 1 to 50% by volume based on the toner particle.

When the amount of the wax is less than 5% by volume based on the nuclear particle, the amount of the wax to be adhered or adsorbed is too small. Therefore, the probability that the nuclear particle is exposed is high and it tends to be difficult to control the adsorptive properties of the metallic soap and the electrostatic properties of the toner particle obtained thereby. Further, as for performance for imparting the mold-release characteristics described above, advantages over the case where nothing is added tend to be lost. Further, when the additive amount exceeds 200% by volume, the wax cannot be adhered or adsorbed to the nuclear particle sufficiently. Thus, it may be liberated in the solution. In this case, even if the metallic soap is added in order to apply an electrical charge to the toner particle, it also adheres to the liberated wax. Thus, electrification characteristics of the toner particle tend to be inhibited. Considering these problems, the amount of the wax can be in the range of 10 to 150% by volume based on the nuclear particle.

Further, when the amount of the metallic soap is less than 1 part by weight based on the toner particle, an electrodeposited film flows since the toner charge amount is insufficient. Further, the toner particle is adhered to the portion other than the portion where a film is to be formed, which tends to cause contamination. When the additive amount exceeds 50 parts by weight, the amount of the ion component in the developing agent becomes excessive and the resistance of the whole developing agent becomes too low. Therefore, the electrophoresis properties of the toner particle tend to be reduced.

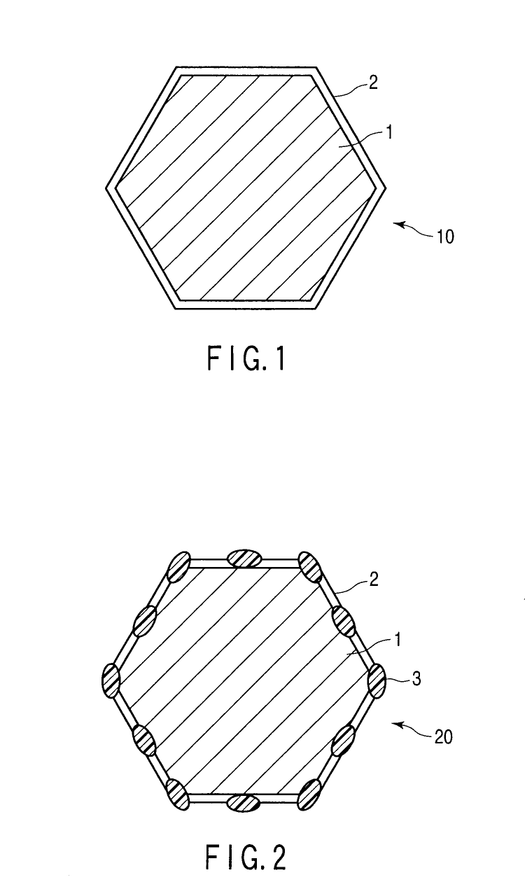

FIG. 2 shows the model view for explaining another example of the structure of toner particle contained in the liquid developing agent of the present invention.

In a toner particle 20, a covering layer is formed using thermoplastic resin fine particles in combination with waxes. As illustrated therein, the toner particle 20 contains the nuclear particle 1, the wax containing layer 2 which is covered on the surface of the nuclear particle 1, thermoplastic resin fine particles 3 which are adhered to the surface of the nuclear particle 1 with the wax containing layer 2, and a covering layer which is adhered on the thermoplastic resin fine particles 3 and the wax containing layer 2 and contains the metallic soap (not shown). Although it is not illustrated, a wax containing layer 2 may intervene between thermoplastic resin fine particles 3 and the nuclear particle 1. Further, the wax containing layer 2 may be covered on the surface of the thermoplastic resin fine particles 3.

The thermoplastic resin fine particles and the wax can be added so that the total amount of the thermoplastic resin fine particles and the wax is in the range of 5 to 200% by volume based on the nuclear particle. In the case where the additive amount is 5% by volume or less, the amount of the wax to be adhered or adsorbed and thermoplastic resin is too small. Therefore, the probability that the nuclear particle is exposed is high and it tends to be difficult to control the electrostatic properties of the toner particle, that is, adsorptive properties of the metallic soap. Further, as for the mold-release characteristics, adhesive properties, or cohesive properties, advantages over the case where nothing is added tend to be lost. Further, when the additive amount is 200% by volume or more, the wax and thermoplastic resin cannot be adhered to the nuclear particle sufficiently. Thus, they may be liberated in the solution. In this case, even if the metallic soap is added in order to apply an electrical charge to the toner particle, it also adheres to the liberated wax and thermoplastic resin. Thus, electrification characteristics of the toner particle tend to be inhibited. Considering these problems, the wax and the thermoplastic resin fine particles can be added so that the total amount of the thermoplastic resin fine particles and the wax is in the range of 10 to 150% by volume based on the nuclear particle.

Examples of the nuclear particle include phosphor particles, resin particles, and coloring resin particles containing a coloring agent.

Examples of the phosphor which can be used in the present invention include red phosphors such as Y₂O₃:Eu:YVO₄:Eu, (Y,Gd)BO₃:Eu, Y₂O₂S:Eu, γ-Zn₃(PO₄)₂:Mn, and (ZnCd)S:Ag+InO; green phosphors such as Zn₂GeO₂:Mn, BaAl₁₂O₁₉:Mn, Zn₂SiO₄:Mn, LaPO₄:Tb, ZnS:(Cu,Al), ZnS:(Au, Cu,Al), (ZnCd)S:(Cu,Al), Zn₂SiO₄:(Mn,As), Y₃Al₅O₁₂:Ce, Gd₂O₂S:Tb, Y₃Al₅O₁₂:Tb, and ZnO:Zn; and blue phosphors such as Sr₅(PO₄)₃CI:Eu, BaMgAl₁₄O₂₃:Eu, BaMgAl₁₆O₂₇:Eu, ZnS:Ag+red pigment, and Y₂SiO₃:Ce.

Specific examples of the inorganic pigment as a coloring agent to be used for coloring resin particles include natural pigments such as ocher; chromates such as chrome yellow, zinc yellow, barium yellow, chrome orange, molybdate red, and chrome green; ferrocyanide compounds such as iron blue; oxides such as titanium oxide, titanium yellow, titanium white, red iron oxide, yellow oxide, zinc oxide, zinc ferrite, zinc white, iron black, cobalt blue, chrome oxide, and spinel green; sulfides such as cadmium yellow, cadmium orange, and cadmium red; sulfate such as barium sulfate; silicates such as calcium silicate and ultramarine blue; metallic powders such as bronze and aluminium; and carbon black.

Specific examples of the organic pigment include natural lakes such as madder lake; nitrone pigments such as naphthol green and naphthol orange; soluble azo-pigments such as benzidine yellow G, Hansa yellow G, Hansa yellow 10G, vulcan orange, Lake Red R, Lake Red C, Lake Red D, Watchung Red, brilliant carmine 6B, pyrazolone orange, Bordeaux 10G (bonmaroom); insoluble azo-pigments such as pyrazolone red, Para Red, toluidine red, ITR red, toluidine red (Lake Red 4R), toluidine maroon, Brilliant fast scarlet, Lake bordeaux 5B; azo pigments such as condensed azo pigments; phthalocyanine pigments such as phthalocyanine blue, phthalocyanine green, brominated phthalocyanine green, and Fast sky blue; anthraquinone pigments such as threne blue; perylene pigments such as perylene maroon; perinon pigments such as perinon orange; quinacridone pigments such as quinacridone and dimethyl quinacridone; dioxazine pigments such as dioxazine violet; condensed polycyclic pigments such as isoindolin and quinophthalone pigments; basic dye lakes such as rhodamine 6B, lake, rhodamine lake B, and malachite green; mordant dye-based pigments such as alizarin lake; vat dye pigments such as indanthrene blue, indigo blue, and anthanthrone orange; fluorescent pigments, azine pigments (diamond black), green gold, and the like.

Examples of the resin material for resin particles to be used as the nuclear particle include styrene and derivatives thereof such as styrene, o-methylstyrene, m-methylstyrene, p-methylstyrene, p-methoxystyrene, p-phenylstyrene, p-chlorstyrene, 3,4-dichlorstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene; ethylene unsaturated monoolefins such as ethylene, propylene, and isobutylene; vinyl halides such as vinyl chloride, vinylidene chloride, and vinyl fluoride; vinyl esters such as vinyl acetate, vinyl propionate, and vinyl benzoate; α-methylene aliphatic monocarboxylic acid esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, diethylaminoethyl methacrylate; acrylic acid esters such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chlorethyl acrylate, and phenyl acrylate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinyl pyrrole, n-vinyl carbazole, N-vinyl indole, and N-vinyl pyrrolidone; vinyl naphthalene acid; and monopolymers or copolymers of vinyl monomers such as acrylic and methacrylic acid derivatives, e.g., acrylonitrile, methacrylonitrile, and acrylamide. Particularly, typical examples of the binding resin include polystyrene, styrene-acrylic acid copolymer, styrene-methacrylic acid copolymer, styrene-acrylonitrile copolymer, styrene-butadiene copolymer, polyester, polyurethane, epoxy resin, silicon resin, polyamide, and the like.

The wax to be used in the present invention has at least polar groups or aromatic substituent groups.

Further, a usable wax in the present invention is selected from the waxes which are substantially insoluble in the insulation solvent to be used at room temperature, have a melting point below the boiling point of the insulation solvent, and is dissolved in the insulation solvent at a temperature higher than the melting point.

When the wax not having polar groups or aromatic substituent groups is used, it is difficult to allow the wax to be sufficiently precipitated on the surface of the nuclear particle. When the wax having polar groups or aromatic substituent groups is used, the wax component serves as a dispersing auxiliary agent of the thermoplastic resin particles in the insulation solvent and it is effective in helping the wax to uniformly adhere to the surface of the nuclear particle. Further, these substituent groups allow for ensuring the affinity and adhesion properties to all surfaces of the nuclear particles.

Further, in the case where the wax is not substantially insoluble in the insulation solvent to be used at room temperature, when it is not cooled to a temperature lower than room temperature, the wax cannot be precipitated. Furthermore, the wax covering layer of the toner particle obtained is dissolved at room temperature and thus it is difficult to handle the liquid developing agent. Further, when the melting point of the wax is higher than the boiling point of the insulation solvent, the wax cannot be dissolved in the solvent. Even if the melting point of the wax is lower than the boiling point of the insulation solvent, the wax cannot be uniformly precipitated on the surface of the nuclear particle, as long as it is not soluble in the insulation solvent.

Examples of the polar group include carboxyl, carbonyl, ester, ether, hydroxyl, and amino groups.

Examples of the aromatic substituent group include phenyl groups.

The wax to be used in the present invention is a solid whose melting point is preferably 40° C. or more, more preferably 50° C. to 160° C. It has a melt viscosity of 10 Pa·S or less at a temperature 10° C. higher than the melting point.

Examples of the wax include paraffin wax having an acid value; natural waxes such as carnauba wax, montan wax, and beeswax; semisynthetic wax such as amide wax and modified montan wax; polyethylene having an acid value; polypropylene having an acid value; and synthetic waxes based on ethylene vinyl acetate copolymer, ethylene acrylic acid copolymer, ethylene acrylic acid ester copolymer, and ethylene styrene copolymer.

Further, examples of the metallic soap to be used in the present invention include copper naphthenate, cobalt naphthenate, nickel naphthenate, iron naphthenate, zinc naphthenate, zirconium octoate, cobalt octoate, nickel octoate, zinc octoate, cobalt dodecylate, nickel dodecylate, zinc dodecylate, 2-ethylhexanoic acid cobalt; and sulfonic acid metal salts such as petroleum sulfonic acid metal salt and metal salts of sulfosuccinate esters.

The wax which is dissolved in the insulation solvent, is adhered to the toner particle physically or chemically, and can produce electrical charges can be used herein.

The electric insulation solvent to be used in the present invention can have a boiling point, in the range of 70 to 250° C., a resistance volume ratio of 109Ω·cm or more, and a permittivity of less than 3.

Usable examples of the electric insulation solvent include aliphatic hydrocarbons such as n-pentane, hexane, and heptane; alicyclic hydrocarbons such as cyclopentane and cyclohexane; halogenated hydrocarbon solvents such as chlorinated alkane, fluorinated alkane, and chlorofluorocarbon; silicone oil, and mixtures thereof. Branched paraffin solvent mixtures such as Isopar G®, Isopar H®, Isopar K®, Isopar L®, Isopar M®, and Isopar V® manufactured by Exxon Corporation can be used.

Further, thermoplastic resin fine particles to be used in the present invention can be produced by using the polymerization method typified by, for example, a suspension polymerization method or an emulsion polymerization method.

For example, acrylic fine particles which can be produced as a dried powder having a primary average particle diameter of 0.1 mm to 5 mm can be used. Further, even if the resin does not have a particulate form and acrylic resins, polyester-based resins, polyamide-based resins, nylon-based resins, and other thermoplastic resins have a granular form or a pellet form, they can be physically ground with a pulverizer, or the like for use.

Alternatively, they can be used after micronizing in the insulation solvent using a bead mill (e.g., a sand grinder) or a ball mill. Further, even if an amphiphilic resin having a hydrophilic site and a hydrophobic site like block polymer and graft polymer is, for example, a nonaqueous dispersion resin (NAD) obtained in the condition where it is dispersed in the insulation solvent, it can be used, as long as it has an average particle diameter of about 0.1 mm to 5 mm. Specific examples are as follows.

That is, the examples include a nongel-like graft polymer which has a molecular structure in which a first polymer chain consisting of a vinyl polymer which is soluble in, for example, an electric insulation medium solution and a second polymer chain consisting of a vinyl polymer which is insoluble in a medium solution are mutually bound via an ester bond and is insoluble in the medium solution as a whole molecule (described in Jpn. Pat. Appln. KOKAI Publication No. 55-71713), or similarly a polymer which has a molecular structure in which the first polymer chain and the second polymer chain are mutually bound via an urethane bond (described in Jpn. Pat. Appln. KOKAI Publication No. 58-122557).

### EXAMPLES

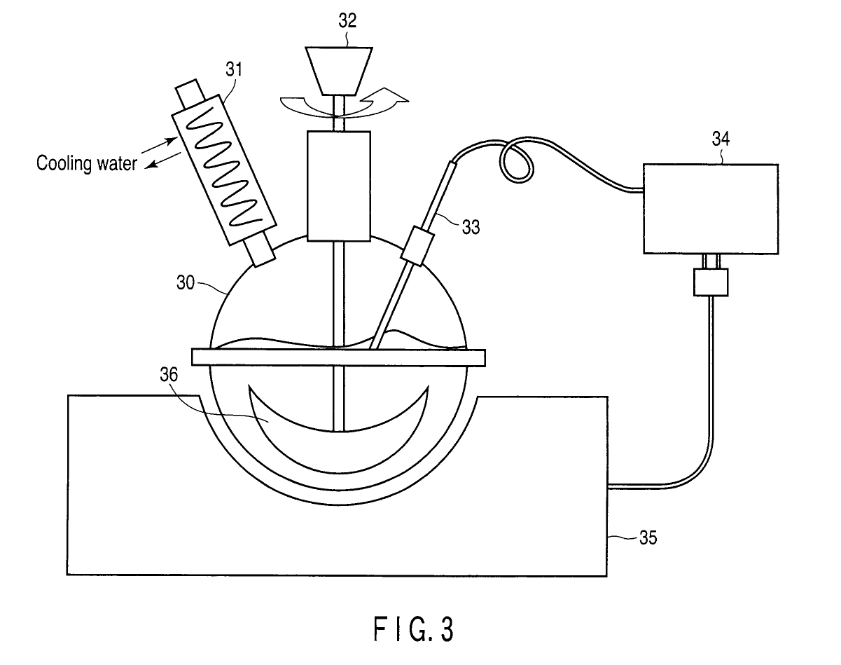

FIG. 3 shows a schematic diagram illustrating an example of an experimental apparatus which can be used in the present invention.

As illustrated therein, the experimental apparatus has a three-necked separable flask 30 which is separable up and down, a stirrer 36 having an impeller inserted into a central opening, an explosion-proof motor 32 which allows the stirrer 36 to rotate and drive and closes the central opening, a Dimroth reflux condenser 31 which is provided on one side of both sides of the central opening, a thermocouple 33 which is inserted from the opening on the other side into the separable flask 30, a relay temperature control unit 34 connected to the thermocouple 33, and a mantle heater 35 which is connected to the relay temperature control unit 34.

In the experimental apparatus, the temperature is always measured by the thermocouple 33 while the contents of the separable flask 30 are stirred using the stirrer 36. On the basis of the measured temperature, the heating of the mantle heater 35 is controlled by the relay temperature control unit 34. Thus, the temperature of the contents can always be kept constant. The solvent vapor from the contents is cooled and condensed by the Dimroth reflux condenser 31 and then returned to the lower container. Thus, an excessive increase of the pressure in the separable flask 30 can be prevented.

### Example 1

First, 180 g of insulating hydrocarbon solvent, Isopar L, manufactured by Exxon Chemical, with a boiling point range of 191 to 205° C. was poured into a 500 ml separable flask as shown in FIG. 3. Further, 2 g of ethylene vinyl acetate copolymer-based wax, 371FP, manufactured by Clariant Japan with a melting point of 99 to 105° C. and a specific gravity of 0.96 and 18 g of red light emitting phosphor particles, Y₂O₂S:Eu having, average particle diameter of 4.5 mm and specific gravity of 5.0 were charged thereto, which was heated and stirred in the stirrer 36 after setting the relay temperature control unit 34 as a temperature controller to 150° C. When the solution temperature reached 150° C., the wax component was completely melted and dissolved in the solvent. The resulting solution was continuously stirred for 2 hours under a condition where the liquid temperature was 150° C. Thereafter, stirring was continued while the solution was cooled to room temperature 25° C. over 1.5 hours. 2 g of zirconium naphthenate, that is, Zr naphthenate, manufactured by Dainippon Ink & Chemicals was added to the phosphor particle dispersion thus obtained with 10% by weight of solids concentration and a liquid developing agent containing red light emitting phosphors was obtained. At this time, the volume ratio of the wax to the phosphor particles was 57.9% by volume.

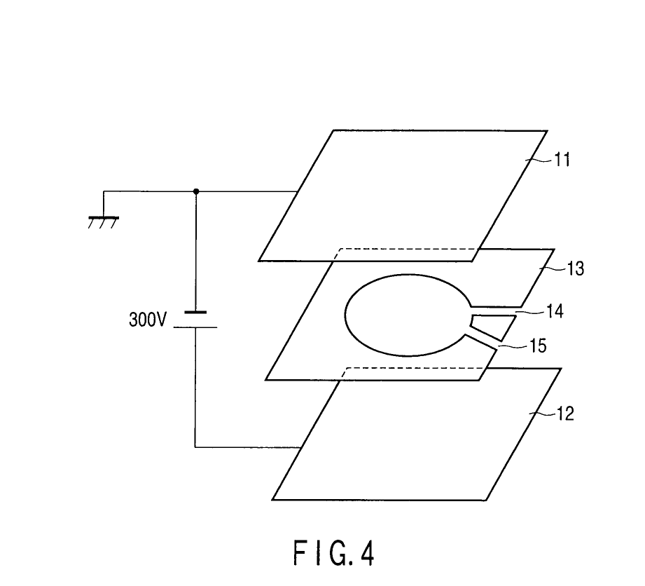

FIG. 4 shows a schematic diagram showing an example of an experimental apparatus for forming the toner layer using the liquid developing agent.

As illustrated therein, in the sandwich cell as the experimental apparatus, a spacer 13 made of Teflon® is disposed between a pair of ITO electrodes 11 and 12 so that a voltage can be applied between the ITO electrodes 11 and 12. The spacer 13 made of Teflon is a 40 mm×40 mm square, and a circular hole area with a radius of 12.5 mm is provided in the center. Parts of the spacer 13 are removed so as to form two paths which lead from the side to the hole area. One of the two paths is used as an air vent port 15 and the other is used as an inlet passage 14 of the liquid developing agent.

The liquid developing agent containing red light emitting phosphors was injected into the sandwich cell as illustrated and a direct current voltage of 300V was applied thereto for 5 seconds, followed by separating the cell. When the appearance of the obtained electrodeposited films was observed, a uniform electrodeposited film of phosphor was formed on the ITO electrode 11 at the gland side in each case and no cohesive properties was observed on the ITO electrode 12 at the cathode side.

This showed that all of these developing agents were positively charged and none of them were negatively charged. In this regard, the average thickness of the electrodeposited film at the anode side was 11 mm at this time. It was found that the electrodeposited film having a sufficient thickness was formed.

### Example 2

180 g of insulating hydrocarbon solvent, Isopar L, manufactured by Exxon Chemical with a boiling point range of 191 to 205° C. was poured into a 500 ml separable flask as shown in FIG. 3. Further, 1 g of ethylene vinyl acetate copolymer-based wax (371FP, manufactured by Clariant Japan) with a melting point of 99 to 105° C. and a specific gravity of 0.96, 1 g of acrylic fine particles (MP4009, manufactured by Soken Chemical) with an average particle diameter of 0.4 mm, a softening temperature of 80° C. and a specific gravity of 1.0, and 18 g of green light emitting phosphor particles, ZnS:Cu,Al (average particle diameter: 5.6 mm, specific gravity: 4.1) were charged thereto, which was heated and stirred after setting the temperature controller to 150° C. The resulting solution was continuously stirred at a constant temperature for 2 hours after the liquid temperature reached 150° C. Thereafter, stirring was continued while the solution was cooled to room temperature (25° C.) over 1.5 hours. 2 g of zirconium naphthenate (Zr naphthenate, manufactured by Dainippon Ink & Chemicals) was added to the phosphor particle dispersion thus obtained with 10% by weight of solids concentration and a liquid developing agent containing green light emitting phosphors was obtained. At this time, the volume ratio of the wax and thermoplastic resin to phosphor particles was 46.5% by volume.

The liquid developing agent containing green light emitting phosphors thus obtained was injected into the sandwich cell as shown in FIG. 4 and a direct current voltage of 300V was applied thereto for 5 seconds, followed by separating the cell. When the appearance of the obtained electrodeposited films was observed, a uniform electrodeposited film of phosphor was formed on the ITO electrode 11 at the gland side in each case and no cohesive properties was observed on the ITO electrode 12 at the cathode side.

This showed that all of these developing agents were positively charged and none of them were negatively charged. At this time, the average thickness of the electrodeposited film at the anode side was 12 mm. It was found that the electrodeposited film having a sufficient thickness was formed.

Here, the term “softening temperature” means the temperature of the heat transmitting medium when a needle-shaped indenter is entered 1 mm by increasing the temperature of the medium at a constant speed while a predetermined load is applied to specimens of a heating bath or heating phase via the needle-shaped indenter which is vertically placed, as described in JIS K 7206:1999 (Plastic-Thermoplastic materials—determination of Vicat softening temperature (VST) (ISO 306: 1994)).

### Example 3

180 g of insulating hydrocarbon solvent (Isopar L, manufactured by Exxon Chemical) with a boiling point range of 191 to 205° C. was poured into a 500 ml separable flask as shown in FIG. 3. Further, 2 g of acrylic acid ester-based wax (ST100, manufactured by NIPPON SHOKUBAI) with a melting point of 50° C. and a specific gravity of 0.90 and 18 g of blue light emitting phosphor particles, ZnS:Ag,Al (average particle diameter: 5.1 mm, specific gravity: 4.1) were charged thereto, which was heated and stirred after setting the temperature controller to 150° C. When the solution temperature reached 150° C., the wax component was completely melted and dissolved in the solvent. The resulting solution was continuously stirred for 2 hours under a condition where the liquid temperature was 150° C. Thereafter, stirring was continued while the solution was cooled to room temperature (25° C.) over 1.5 hours. 2 g of zirconium naphthenate (Zr naphthenate, manufactured by Dainippon Ink & Chemicals) was added to the phosphor particle dispersion thus obtained with 10% by weight of solids concentration and a liquid developing agent containing blue light emitting phosphors was obtained. At this time, the volume ratio of the wax to the phosphor particles was 50.6% by volume.

The liquid developing agent containing blue light emitting phosphors thus obtained was injected into the sandwich cell as shown in FIG. 4 and a direct current voltage of 300V was applied thereto for 5 seconds, followed by separating the cell. When the appearance of the obtained electrodeposited films was observed, a uniform electrodeposited film of phosphor was formed on the ITO electrode 11 at the gland side in each case and no cohesive properties was observed on the ITO electrode 12 at the cathode side. This showed that all of these developing agents were positively charged and none of them were negatively charged. At this time, the average thickness of the electrodeposited film at the anode side was 12 mm. It was found that the electrodeposited film having a sufficient thickness was formed.

### Example 4

### Preparation of Resin Dispersions

10 parts by weight of styrene acrylic resin (trade name: CPR-100, manufactured by Mitsui Chemicals) with a specific gravity of 1.0 and a glass transition point (Tg) of 59° C. and 90 parts by weight of insulating hydrocarbon solvent (Isopar L, manufactured by Exxon Chemical) with a boiling point range of 191 to 205° C. were charged into a sand grinder, which was mixed and stirred at 1500 rpm for 4 hours while a vessel was water-cooled. Then, resin dispersions with an average particle diameter of 1.0 mm and a solid content of 10% by weight was obtained. The resin was prevented from being plasticized by paying attention to keep the temperature below the Tg temperature of the resin during mixing.

Next, 171 g of insulating hydrocarbon solvent (Isopar L, manufactured by Exxon Chemical) with a boiling point range of 191 to 205° C. was poured into a 500 ml separable flask as shown in FIG. 3. Further, 1 g of montanic acid-based wax (Licowax E, manufactured by Clariant Japan) with a melting point of 99 to 105° C. and a specific gravity of 1.0, 10 g of resin dispersions (resin content: 1 g) obtained by preparing the resin dispersions with an average particle diameter of 1.0 mm and a solid content of 10% by weight, and 18 g of green light emitting phosphor particles, ZnS:Cu,Al (average particle diameter: 5.6 mm, specific gravity: 4.1) were charged thereto, which was heated and stirred after setting the temperature controller to 150° C. The resulting solution was continuously stirred at a constant temperature for 2 hours after the liquid temperature reached 150° C. Thereafter, stirring was continued while the solution was cooled to room temperature (25° C.) over 1.5 hours. 2 g of zirconium naphthenate (Zr naphthenate, manufactured by Dainippon Ink & Chemicals) was added to the phosphor particle dispersion thus obtained with 10% by weight of solids concentration and a liquid developing agent containing green light emitting phosphors was obtained. At this time, the volume ratio of the wax and thermoplastic resin to phosphor particles was 45.6% by volume.

The liquid developing agent containing green light emitting phosphors thus obtained was injected into the sandwich cell as shown in FIG. 4 and a direct current voltage of 300V was applied thereto for 5 seconds, followed by separating the cell. When the appearance of the obtained electrodeposited films was observed, a uniform electrodeposited film of phosphor was formed on the ITO electrode 11 at the gland side in each case and no cohesive properties was observed on the ITO electrode 12 at the cathode side. This showed that all of these developing agents were positively charged and none of them were negatively charged. At this time, the average thickness of the electrodeposited film at the anode side was 12 mm. It was found that the electrodeposited film having a sufficient thickness was formed.

### Example 5

180 g of insulating hydrocarbon solvent (Isopar L, manufactured by Exxon Chemical) with a boiling point range of 191 to 205° C. was poured into a 500 ml separable flask as shown in FIG. 3. Further, 1 g of oxidized polyethylene-based wax (E-330, manufactured by Sanyo Chemical Industries, Ltd.) with a softening temperature of 104° C., a specific gravity of and an acid value of 17 mgKOH/g, 1 g of styrene-acrylic fine particles (FS301, manufactured by Nippon Paint Co., Ltd.) with an average particle diameter of 1.0 mm, a glass transition point (Tg) of 65° C., a softening temperature of 131° C., and a specific gravity of 1.0, and 18 g of zinc oxide particles (LPZINC-2, manufactured by Sakai Chemical Industry Co., Ltd.), (average particle diameter: 2 mm, specific gravity: 5.8) were charged thereto, which was heated and stirred after setting the temperature controller to 150° C. The resulting solution was continuously stirred at a constant temperature for 2 hours after the liquid temperature reached 150° C. Thereafter, stirring was continued while the solution was cooled to room temperature 25° C. over 1.5 hours. 2 g of zirconium naphthenate, that is, Zr naphthenate, manufactured by Dainippon Ink & Chemicals was added to the phosphor particle dispersion thus obtained with 10% by weight of solids concentration and a liquid developing agent containing zinc oxide particles was obtained. At this time, the volume ratio of the wax and thermoplastic resin to zinc oxide particles was 66.5% by volume.

The liquid developing agent containing zinc oxide particles thus obtained was injected into the sandwich cell as shown in FIG. 4 and a direct current voltage of 300V was applied thereto for 5 seconds, followed by separating the cell. When the appearance of the obtained electrodeposited films was observed, a uniform electrodeposited film of phosphor was formed on the ITO electrode 11 at the gland side in each case and no cohesive properties was observed on the ITO electrode 12 at the cathode side. This showed that all of these developing agents were positively charged and none of them were negatively charged. At this time, the average thickness of the electrodeposited film at the anode side was 9 mm.

### Example 6

180 g of insulating hydrocarbon solvent, that is, Isopar L, manufactured by Exxon Chemical with a boiling point range of 191 to 205° C. was poured into a 500 ml separable flask as shown in FIG. 3. Further, 0.1 g of ethylene vinyl acetate copolymer-based wax, that is, 371FP, manufactured by Clariant Japan with a melting point of 99 to 105° C. and a specific gravity of 0.96 and 19.9 g of red light emitting phosphor particles, Y₂O₂S:Eu having average particle diameter of 4 mm and specific gravity of 5.0 were charged thereto, which was heated and stirred after setting the temperature controller to 150° C. When the solution temperature reached 150° C., the wax component was completely melted and dissolved in the solvent. The resulting solution was continuously stirred for 2 hours under a condition where the liquid temperature was 150° C. Thereafter, stirring was continued while the solution was cooled to room temperature 25° C. over 1.5 hours. 2 g of zirconium naphthenate, that is, Zr naphthenate, manufactured by Dainippon Ink & Chemicals was added to the phosphor particle dispersion thus obtained with 10% by weight of solids concentration and a liquid developing agent containing red light emitting phosphors was obtained. At this time, the volume ratio of the wax to the phosphor particles was 2.6% by volume.

The liquid developing agent containing red light emitting phosphors thus obtained was injected into the sandwich cell and a direct current voltage of 300V was applied thereto for 5 seconds, followed by separating the cell. When the appearance of the obtained electrodeposited films was observed, there were very few toner particles adhered on the ITO electrode 12 at the cathode side. However, most of the toner particles were positively charged and a uniform electrodeposited film of phosphor was formed on the ITO electrode 11 at the gland side. At this time, the average thickness of the electrodeposited film at the anode side was 9 mm.

### Example 7

180 g of insulating hydrocarbon solvent, that is, Isopar L, manufactured by Exxon Chemical with a boiling point range of 191 to 205° C. was poured into a 500 ml separable flask as shown in FIG. 3. Further, 6 g of ethylene vinyl acetate copolymer-based wax 371FP, manufactured by Clariant Japan with a melting point of 99 to 105° C. and a specific gravity of 0.96 and 14 g of red light emitting phosphor particles, Y₂O₂S:Eu having average particle diameter of 4 mm and specific gravity: 5.0 were charged thereto, which was heated and stirred after setting the temperature controller to 150° C. When the solution temperature reached 150° C., the wax component was completely melted and dissolved in the solvent. The resulting solution was continuously stirred for 2 hours under a condition where the liquid temperature was 150° C. Thereafter, stirring was continued while the solution was cooled to room temperature 25° C. over 1.5 hours. 2 g of zirconium naphthenate, that is, Zr naphthenate, manufactured by Dainippon Ink & Chemicals was added to the phosphor particle dispersion thus obtained with 10% by weight of solids concentration and a liquid developing agent containing red light emitting phosphors was obtained. At this time, the volume ratio of the wax to the phosphor particles was 223.2% by volume. The liquid developing agent containing red light emitting phosphors thus obtained was injected into the sandwich cell as shown in FIG. 4 and a direct current voltage of 300V was applied thereto for 5 seconds, followed by separating the cell. When the appearance of the obtained electrodeposited films was observed, a film of excessive fine particles of wax which were liberated from phosphor particles or could not be adhered was preferentially formed on the ITO electrode 11 at the gland side. Thus, imbalances in the film composition can tend to be caused in a thickness direction. However, no cohesive properties were observed on the ITO electrode 12 at the cathode side and a film having an average thickness of 13 mm was obtained.

### Example 8

180 g of insulating hydrocarbon solvent, that is, Isopar L, manufactured by Exxon Chemical with a boiling point range of 191 to 205° C. was poured into a 500 ml separable flask as shown in FIG. 3. Further, 0.05 g of ethylene vinyl acetate copolymer-based wax (371FP, manufactured by Clariant Japan) with a melting point of 99 to 105° C. and a specific gravity of 0.96, 1 g of acrylic fine particles (MP4009, manufactured by Soken Chemical) with an average particle diameter of 0.4 mm, a softening temperature of 80° C., and a specific gravity of 1.0, and 19.85 g of green light emitting phosphor particles, ZnS:Cu,Al (average particle diameter: 5.6 mm, specific gravity: 4.1) were charged thereto, which was heated and stirred after setting the temperature controller to 150° C. The resulting solution was continuously stirred at a constant temperature for 2 hours after the liquid temperature reached 150° C. Thereafter, stirring was continued while the solution was cooled to room temperature (25° C.) over 1.5 hours. 2 g of zirconium naphthenate (Zr naphthenate, manufactured by Dainippon Ink & Chemicals) was added to the phosphor particle dispersion thus obtained with 10% by weight of solids concentration and a liquid developing agent containing green light emitting phosphors was obtained. At this time, the volume ratio of the wax and thermoplastic resin to phosphor particles was 3.14% by volume.

The liquid developing agent containing green light emitting phosphors thus obtained was injected into the sandwich cell shown in FIG. 4 that was produced by sandwiching the spacer made of Teflon having aperture radius of 12.5 mm, film thickness of 300 mm between the ITO electrodes and a direct current voltage of 300V was applied thereto for 5 seconds, followed by separating the cell. When the appearance of the obtained electrodeposited films was observed, there were also very few toner particles on the ITO electrode 12 at the cathode side. However, most of the toner particles were positively charged and a uniform electrodeposited film of phosphor was formed on the ITO electrode 11 at the gland side. At this time, the average thickness of the electrodeposited film at the anode side was 11 mm.

### Example 9

180 g of insulating hydrocarbon solvent that is Isopar L, manufactured by Exxon Chemical with a boiling point range of 191 to 205° C. was poured into a 500 ml separable flask as shown in FIG. 3. Further, 1 g of ethylene vinyl acetate copolymer-based wax 371FP, manufactured by Clariant Japan with a melting point of 99 to 105° C. and a specific gravity of 0.96, 6 g of acrylic fine particles, that is, MP4009, manufactured by Soken Chemical with an average particle diameter of 0.4 mm, a softening temperature of 80° C., and a specific gravity of 1.0, and 13 g of green light emitting phosphor particles, ZnS:Cu,Al having average particle diameter: 5.6 mm, specific gravity: 4.1 were charged thereto, which was heated and stirred after setting the temperature controller to 150° C. The resulting solution was continuously stirred at a constant temperature for 2 hours after the liquid temperature reached 150° C. Thereafter, stirring was continued while the solution was cooled to room temperature (25° C.) over 1.5 hours. 2 g of zirconium naphthenate (Zr naphthenate, manufactured by Dainippon Ink & Chemicals) was added to the phosphor particle dispersion thus obtained with 10% by weight of solids concentration and a liquid developing agent containing green light emitting phosphors was obtained. At this time, the volume ratio of the wax and thermoplastic resin to phosphor particles was 222.0% by volume.

The liquid developing agent containing green light emitting phosphors thus obtained was injected into the sandwich cell as shown in FIG. 4 and a direct current voltage of 300V was applied thereto for 5 seconds, followed by separating the cell. When the appearance of the obtained electrodeposited films was observed, a film of excessive fine particles of wax which were liberated from phosphor particles or could not be adhered was preferentially formed on the ITO electrode 11 at the gland side. Thus, imbalances in the film composition tend to be caused in a thickness direction. However, no cohesive properties were observed on the ITO electrode 12 at the cathode side and a film having an average thickness of 14 mm was obtained.

### Comparative Example 1

180 g of insulating hydrocarbon solvent, that is, Isopar L, manufactured by Exxon Chemical was poured into a 500 ml separable flask as shown in FIG. 3. Further, 2 g of synthetic paraffin wax (FT100, manufactured by Nippon Seiro Co., Ltd.) with a melting point of 98° C. and a specific gravity of 0.92 and without any of polar groups such as carbonyl, ester, ether, hydroxyl, and amino groups or aromatic substituent groups such as phenyl groups, and 18 g of blue light emitting phosphor particles, ZnS:Ag,Al (average particle diameter: 5.1 mm, specific gravity: 4.1) were charged thereto, which was heated and stirred after setting the temperature controller to 150° C. The resulting solution was continuously stirred at a constant temperature for 2 hours after the liquid temperature reached 150° C. Thereafter, stirring was continued while the solution was cooled to room temperature (25° C.) over 1.5 hours. 2 g of zirconium naphthenate (Zr naphthenate, manufactured by Dainippon Ink & Chemicals) was added to the phosphor particle dispersion thus obtained with 10% by weight of solids concentration and a liquid developing agent containing blue light emitting phosphors was obtained. At this time, the volume ratio of the wax to the phosphor particles was 49.5% by volume.

The liquid developing agent containing blue light emitting phosphors thus obtained was injected into the sandwich cell as shown in FIG. 4 and a direct current voltage of 300V was applied thereto for 5 seconds, followed by separating the cell. When the appearance of the obtained electrodeposited films was observed, an electrodeposited film of phosphor was partially formed on the ITO electrode 11 at the gland side and a number of phosphor particles were adhered to the ITO electrode 12 at the cathode side. Further, a number of uncoated colorless wax particles were also observed in phosphor particles and it could be confirmed that a number of particles which were negatively charged or not charged were present.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid developing agent comprising:
an electric insulation solvent;
a nuclear particle which is dispersed in the electric insulation solvent and has an average particle diameter of 1 to 30 mm;
a covering layer which is provided on the surface of the nuclear particle and contains a wax which has at least one of polar groups and aromatic substituent groups, is substantially insoluble in the electric insulation solvent at room temperature, has a melting point below a boiling point of the electric insulation solvent, and is dissolved in the insulation solvent at a temperature higher than the melting point; and
a toner particle containing a metallic soap added onto the covering layer.

2. The liquid developing agent according to claim 1, wherein an average particle diameter of the nuclear particle is 1 to 10 mm.

3. The liquid developing agent according to claim 1, wherein the polar group is at least one selected from the group consisting of carboxyl, carbonyl, ester, ether, hydroxyl, and amino groups.

4. The liquid developing agent according to claim 1, wherein the aromatic substituent group is a phenyl group.

5. The liquid developing agent according to claim 1, wherein the covering layer further contains thermoplastic resin fine particles having an average particle diameter smaller than the nuclear particle.

6. The liquid developing agent according to claim 5, wherein the thermoplastic resin fine particle has an average particle diameter of 0.1 to 5 mm.

7. A process for producing a liquid developing agent, comprising:
melting a wax which has at least one of polar groups and aromatic substituent groups, is substantially insoluble in the electric insulation solvent at room temperature, has a melting point below a boiling point of the electric insulation solvent, and is dissolved in the insulation solvent at a temperature higher than the melting point, while the wax is heated and stirred with the nuclear particle at a temperature below the boiling point of the electric insulation solvent;
then allowing the wax to be precipitated on the surface of the nuclear particle by cooling the wax to a degree below the melting point of the wax; and
subsequently adding a metallic soap.

8. The process according to claim 7, wherein the polar group is at least one selected from the group consisting of carboxyl, carbonyl, ester, ether, hydroxyl, and amino groups.

9. The process according to claim 7, wherein the aromatic substituent group is a phenyl group.

10. The process according to claim 7, wherein the nuclear particle has an average particle diameter of 1 to 30 mm.

11. The process according to claim 10, wherein the nuclear particle has an average particle diameter of 1 to 10 mm.

12. A process for producing a liquid developing agent, comprising:
melting a wax which has at least one of polar groups and aromatic substituent groups, is substantially insoluble in the electric insulation solvent at room temperature, has a melting point below a boiling point of the electric insulation solvent, and is dissolved in the insulation solvent at a temperature higher than the melting point, while the wax is heated and stirred with thermoplastic resin fine particles substantially insoluble in the electric insulation solvent and the nuclear particle at a temperature below the boiling point of the electric insulation solvent;
allowing the wax to be precipitated on the surface of the nuclear particle by cooling the wax to a degree below the melting point of the wax while the thermoplastic resin fine particles are adhered to the surface of the nuclear particle; and
subsequently adding a metallic soap.

13. The process according to claim 12, wherein the polar group is at least one selected from the group consisting of carboxyl, carbonyl, ester, ether, hydroxyl, and amino groups.

14. The process according to claim 12, wherein the aromatic substituent group is a phenyl group.

15. The process according to claim 12, wherein the nuclear particle has an average particle diameter of 1 to 30 mm.

16. The process according to claim 15, wherein the nuclear particle has an average particle diameter of 1 to 10 mm.

17. The process according to claim 15, wherein the thermoplastic resin fine particle has an average particle diameter of 0.1 to 5 mm.
